(19) United States
(12) Patent Application Publication
(10) Pub. No.: US 2014/0303299 A1
(43) Pub. Date: Oct. 9, 2014

(54) Silicone Resins And Their Use in Polymers

(71) Applicants: Dow Corning Corporation, Midland, MI (US); Dow Corning Toray Co., Ltd., Tokyo (JP)

(72) Inventors: Michael Depierro, Midland, MI (US); David Pierre, BXL (Watermael-boit) (BE); Satoshi Onodera, Ichihara City (JP); Vincent Rerat, Tubize (BE)

(21) Appl. No.: 14/358,310

(22) PCT Filed: Nov. 14, 2012
(86) PCT No.: PCT/US2012/065059

§ 371 Date: May 15, 2014

(30) Foreign Application Priority Data
Nov. 17, 2011 (GB) 1119813.2

(51) Int. Cl. C08G 77/56; C09D 183/14; C09D 5/18; C08G 77/58; C08L 69/00

(52) U.S. Cl. CPC C08G 77/56; C08G 77/58; C08L 69/00; C09D 5/18; C09D 183/14
USPC 524/162; 528/30; 525/389; 524/405; 524/588; 524/433; 524/211; 524/416; 524/418; 524/387; 524/503

(57) ABSTRACT

The invention relates to silicone resins comprising metallosiloxane which contains Si—O-Metal bonds or borosiloxane containing Si—O—B bonds and potentially Si—O—Si and/or B—O—B bonds. It also relates to the preparation of such silicone resins and to their use in thermoplastic or thermosetting organic polymer or rubber or thermoplastic/rubber blends compositions to reduce the flammability or enhanced scratch and/or abrasion resistance of the organic polymer compositions. It further relates to coatings made of such silicone resins for scratch resistance enhancement or flame retardant properties.

The invention relates to silicone resins comprising metallosiloxane which contains Si—O-Metal bonds or borosiloxane containing Si—O—B bonds and potentially Si—O—Si and/or B—O—B bonds. It also relates to the preparation of such silicone resins and to their use in thermoplastic or thermosetting organic polymer or rubber or thermoplastic/rubber blends compositions to reduce the flammability or enhance scratch and/or abrasion resistance of the organic polymer compositions. It further relates to coatings made of such silicone resins for scratch resistance enhancement or flame retardant properties.

### BACKGROUND

Development of efficient halogen-free flame retardant additives for thermoplastics and thermosets is still a great need for many industrial applications. New upcoming regulation such as European harmonized EN45545 norm as well as growing green pressure are pushing the market to develop new effective halogen-free solutions. In the recent years, many researches were made in the field of halogen-free flame retardant. Silicone-based materials are of particular interest in this field.

Even if the synthesis of borosiloxane structures are known in the literature, the obtention of phosphorylated boro- metallo- or borometallosiloxanes presenting unexpected higher fire retardant efficiency and outstanding thermal stability compared to their “pure” silicone based and non phosphorylated counterparts were not reported.

WO2008/018981 discloses silicone polymers containing boron, aluminum and/or titanium, and having silicon-bonded branched alkoxy groups.

US2009/0227757 describes a modified polyaluminosiloxane obtained by treating a polyaluminosiloxane with a silane coupling agent represented by the formula SiR1R2R3(CH₂)₃X wherein each of R1, R2 and R3 is independently an alkyl group or an alkoxy group, X is a methacryloxy group, a glycidoxy group, an amino group, a vinyl group or a mercapto group with proviso that at least two of R1, R2 and R3 are alkoxy groups.

Japanese Patent Publication N0 04-359056 discloses a resin composition obtained by adding a silica-sol to a resin solution of an organosilicon polymer expressed by the formula (SiO_{4/2})ₗ(PO_{5/2})ₘ(BO_{3/2})ₙ where l, m and n are (99-40), (0.5-30), (0.5-30) and the polymer has an average molecular weight of 500-30,000.

US2010/0191001 discloses a process for performing hydrolysis and condensation of an epoxy-functional silane with boric acid, the condensate formed in the reaction being based on Si—O—B and/or Si—O—Si bonds.

U.S. Pat. No. 6,716,952 discloses flame retardant compositions containing a polymer comprising silicon, boron and oxygen and having a skeleton substantially formed by a silicon-oxygen bond and a boron-oxygen bond.

JP 57-076039 discloses flame retardant polyolefin composition that is made by adding a borosiloxane resin to a polyolefin.

U.S. Pat. No. 4,152,509 discloses borosiloxane polymers produced by heating at least one of boric acid compound with phenylsilane to effect polycondensation reaction.

US 20100316876 describes a borosiloxane adhesive which is said to have high resistance to moisture, high transparency, and excellent adhesion to various substrates. Moreover, the borosiloxane adhesive has high adhesion during and after exposure to temperatures above the decomposition temperature of the adhesive, low flammability (as evidenced by low heat release rate), and high char yield.

GB2310667 discloses poly(borosiloxanes) and a method for the preparation of boron and silicon oxynitrides comprising effecting a nitriding pyrolysis of such poly(borosiloxanes).

U.S. Pat. No. 7,208,536 discloses a polyolefin resin composition comprising a high crystalline polypropylene resin, a rubber component, an inorganic filler and an aluminosiloxane masterbatch, with excellent damage resistance such as anti-scratch characteristic thereby giving very low surface damage, excellent heat resistance, good rigidity and impact properties and injection moldability, for car interior or exterior parts.

GB2273505 discloses a silicone elastomer obtainable by condensation of polydimethyl- and/or methylhydrosiloxane diols with a methylphenylsilicone polymer in the presence of reactive compounds of silicon, boron or nitrogen.

US 2011/0213065 disclose the modification of crystal structure of hydrogarnets through the inclusion of silicate and/or phosphorus to afford flame retardants having higher flame retardant efficiency and higher thermal stability compared to classical aluminum trihydrate (ATH).

US2009/0226609 discloses aluminosiloxanes, titanosiloxanes, and (poly)stannosiloxanes and methods for preparing these siloxanes.

GB991284 discloses phosphonated metalloxane-siloxane polymers where P and Al are bonded to Si through oxygen containing bonds.

GB1282285 discloses the production of rubbers including organopolysiloxane gum having a structure consisting of silicon, oxygen, boron and phosphorus atoms.

However, even if some of the before mentioned patents describe halogen-free borosiloxane, they show only limited flame retardant performances narrowed down to anti-dripping effect following UL-94 test. In view of the state of the art, it is the object of the present invention to provide a flame retardant additive system based on strong synergy based on phosphorylated boro- metalo- or borometalosilicones technology which is cheap, easy to process and with high thermal and moisture stability making them suitable for applications where high processing temperature are required. Moreover, it was demonstrated that the additives presented in the following patent were suitable to reach new norms requirements and particularly efficient at reducing fumes emission of the final compound.

### SUMMARY OF THE INVENTION

The invention provides a silicone resin comprising
a. at least one metallosiloxane which contains Si—O-M bonds whose Metal M is chosen from Transition Group metals, Sn, Zr and IIIA Group elements and
b. at least one organic group which contains phosphorus and/or nitrogen with the proviso that when Metal M is Al, the organic group is different than —(CH₂)₃NH₂
c. and when present phosphorous is linked to Si through carbon atom(s).

Metals M as defined herein encompass transition metals containing Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, Hg, Rf, Db, Sg, Bh, Hs, Mt, Ds, Rg, Cn and all elements from Group IIIA (i.e. B, Al, Ga, In and Tl), Sn and Zr. Group IIIa comprises boron, the first element of Group IIIA which is in fact a metalloid instead of a metal. Nevertheless for the sake of convenience boron is considered to be a Metal M in the rest of the present specification. Preferably the Metal M is chosen from Period 4 of the transition metals (Sc, Ti, V, Cr, Mn, Fe, Co, Ni, Cu, Zn). Preferably the Metal M is chosen from nickel, copper and zinc. In other preferred embodiments, the Metal M is chosen from boron, titanium and aluminum.

Preferably, the silicone resin contains both boron and metal atom from group IIIa and/or transition metals. For example, the silicone resin contains both boron and aluminum elements.

While borosiloxane structures or other Metal containing structures are known, no prior art suggests a silicone structure containing phosphorous or nitrogen in addition to B or M and demonstrating unexpected flame retardant performances synergism compared to their non phosphorus or nitrogen containing counterpart. We have found that such structures may form resins having a high degree of flame retardancy. We have also found that such structures were of particular heat stability compared to their non phosphorus or nitrogen containing counterparts, making them suitable for applications where very high processing temperatures are required such as in polycarbonate or polyamide. Therefore the silicone resin of the invention contains also at least one organic group containing phosphorus and/or nitrogen.

It is important that the silicon and phosphorous atoms if present are linked trough carbon atoms. Other bonds than —C-containing bonds for example —O— containing bonds are prone to hydrolysis and degradation while carbon links can be much more resistant. For example the group linking silicon to phosphorous can contain from 1 to 20 carbon atoms. The link can be a simple or branched alkyl, alkenyl (unsaturated), simple or substituted arylalkyl or aryl group. Preferably the silicon and nitrogen atoms if present are linked also through carbon atoms.

The silicone resin composition defined in the present patent can also be obtained through any physical combination of phosphorylated borosiloxane with phosphorylated aluminosiloxane, phosphorylated borosiloxane with aluminosiloxane or phosphorylated aluminosiloxane with borosiloxane.

Preferably the silicone resin of the invention comprises at least one P-containing organic group. The presence of a P-containing organic group is particularly efficient to provide flame retardancy properties to the resin and P-containing compounds are readily available to being used as raw materials able to form the resin.

The silicone resin preferably contains T units; D; M′ and/or Q units. The resin is characterized by a majority of successive Si—O-M units where the Si is selected from R₃SiO_{1/2} (M′ units), R₂SiO_{2/2} (D units), RSiO_{3/2} (T units) and SiO_{4/2} (Q units). The resin further contains polyorganosiloxanes, also known as silicones, generally comprising repeating siloxane units selected from R₃SiO_{1/2} (M′ units), R₂SiO_{2/2} (D units), RSiO_{3/2} (T units) and SiO_{4/2} (Q units), in which each R represents an organic group or hydrogen or a hydroxyl group. The silicone resin has preferably some tridimensional network, as opposed to a “fluid” silicone which is essentially linear. Branched silicone resins containing T and/or Q units, optionally in combination with M′ and/or D units, are preferred. In the branched silicone resins of the invention, at least 25% of the siloxane units are preferably T and/or Q units. More preferably, at least 75% of the siloxane units in the branched silicone resin are T and/or Q units.

Preferably, the resin contains at least one phosphorus containing group present in a M′ unit of the formula RPR2SiO1/2 and/or D unit of the formula RPRSiO2/2 and/or a T unit of the formula R_{P}SiO3/2, where R_{P} is an alkyl, cycloalkyl, alkenyl, alkynyl or aryl group having 1 to 20 carbon atoms containing a phosphorus substituent. This phosphorus substituent can be at an oxidation state of −3, −1, +1, +3 or +5, preferably −3, +3 or +5. It can be phosphine and/or phosphine oxide and/or phosphinate and/or phosphinite and/or phosphonite and/or phosphite, and/or phosphonate and/or phosphate substituent, and each group R is independently an alkyl, cycloalkyl, alkenyl, alkynyl or aryl group having 1 to 20 carbon atoms.

More preferably, the phosphorus containing group is present in a T unit of the formula R_{P}SiO3/2.

Preferably, the group R_{P} has the formula

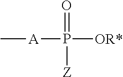

where A is a divalent hydrocarbon group having 1 to 20 carbon atoms or an —OR* group, R* is a hydrogen, alkyl or aryl group having 1 to 12 carbon atoms, and Z is a group of the formula —OR* or an alkyl, cycloalkyl, alkenyl, alkynyl or aryl group having 1 to 20 carbon atoms. When 2 —OR* groups are present on the P group, they can be different.

The phosphinate substituent can comprise a 9,10 dihydro-9-oxa-10-phosphaphenanthrene-10-oxide group, sometimes known as DOPO group. Therefore, preferably the group R_{P} has the formula

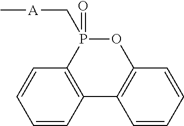

where A is a divalent group having 1 to 20 carbon atoms, for example a hydrocarbon group forming 2-DOPO-ethyl or 3-DOPO-propyl. The divalent group can also be an aryl containing group for example forming DOPO-Hydroquinone.
Alternatively, the P-organic group can be

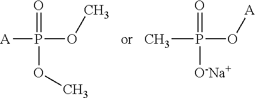

where A is the linking group to the silicon part. A can be rather a simple or branched alkyl, alkenyl (unsaturated), simple or substituted arylalkyl or aryl group.

In some preferred embodiments, the branched silicone resin of the invention preferably contains at least one organic nitrogen-containing group present in a T unit of the formula R_{N}SiO_{3/2}, where R_{N} is an alkyl, cycloalkyl, alkenyl, alkynyl or aryl group having 1 to 20 carbon atoms containing a organic nitrogen substituent.

In one preferred type of resin according to the invention the organic group containing nitrogen is a heterocyclic group present as a group of the formula

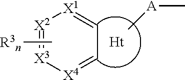

where X¹, X², X³ and X⁴ independently represent a CH group or a N atom and form a benzene, pyridine, pyridazine, pyrazine, pyrimidine or triazine aromatic ring; Ht represents a heterocyclic ring fused to the aromatic ring and comprising 2 to 8 carbon atoms, 1 to 4 nitrogen atoms and optionally 1 or 2 oxygen and/or sulphur atoms; A represents a divalent organic linkage having 1 to 20 carbon atoms bonded to a nitrogen atom of the heterocyclic ring; the heterocyclic ring can optionally have one or more substituent groups selected from alkyl, substituted alkyl, cycloalkyl, alkenyl, alkynyl, aryl and substituted aryl groups having 1 to 12 carbon atoms and amino, nitrile, amido and imido groups; and R³ₙ, with n=0-4, represents an alkyl, substituted alkyl, cycloalkyl, alkenyl, alkynyl, aryl or substituted aryl group having 1 to 40 carbon atoms, or an amino, nitrile, amido or imido group or a carboxylate —C(═O)—O—R⁴, oxycarbonyl —O—(C═O)—R⁴, carbonyl —C(═O)—R⁴, or an oxy —O—R⁴ substituted group with R⁴ representing hydrogen or an alkyl, cycloalkyl, alkenyl, alkynyl, aryl, or substituted aryl groups having 1 to 40 carbon atoms, substituted on one or more positions of the aromatic ring, or two groups R³ can be joined to form a ring system comprising at least one carbocyclic or heterocyclic ring fused to the aromatic ring.

The heterocyclic ring Ht is preferably not a fully aromatic ring, i.e. it is preferably not a pyridine, pyridazine, pyrazine, pyrimidine or triazine aromatic ring. The heterocyclic ring Ht can for example be an oxazine, pyrrole, pyrroline, imidazole, imidazoline, thiazole, thiazoline, oxazole, oxazoline, isoxazole or pyrazole ring. Examples of preferred heterocyclic ring systems include benzoxazine, indole, benzimidazole, benzothiazole and benzoxazole. In some preferred resins the heterocyclic ring is an oxazine ring so that R_{N} is a group of the formula

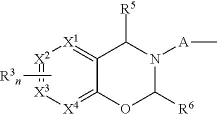

where X¹, X², X³ and X⁴, A, R³ and n are defined as above and R⁵ and R⁶ each represent hydrogen, an alkyl, substituted alkyl, cycloalkyl, alkenyl, alkynyl, aryl or substituted aryl group having 1 to 12 carbon atoms, or an amino or nitrile group. The group can for example be a benzoxazine group of the formula

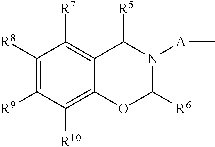

where R⁷, R⁸, R⁹ and R¹⁰ each represent hydrogen, an alkyl, substituted alkyl, cycloalkyl, alkenyl, alkynyl, aryl or substituted aryl group having 1 to 40 carbon atoms, or an amino, nitrile, amido or imido group or a carboxylate —C(═O)—O—R⁴, oxycarbonyl —O—(C═O)—R⁴, carbonyl —C(═O)—R⁴, or an oxy —O—R⁴ substituted group with R⁴ representing hydrogen or an alkyl, cycloalkyl, alkenyl, alkynyl, aryl, or substituted aryl groups having 1 to 40 carbon atoms, or R⁷ and R⁸, R⁸ and R⁹ or R⁹ and R¹⁰ can each be joined to form a ring system comprising at least one carbocyclic or heterocyclic ring fused to the benzene ring.

The oxazine or other heterocyclic ring Ht can alternatively be bonded to a pyridine ring to form a heterocyclic group of the formula

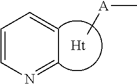

The benzene, pyridine, pyridazine, pyrazine or triazine aromatic ring can be annelated to a ring system comprising at least one carbocyclic or heterocyclic ring to form an extended ring system enlarging the pi-electron conjugation. A benzene ring can for example be annelated to another benzene ring to form a ring system containing a naphthanene moiety

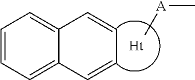

such as a naphthoxazine group, or can be annelated to a pyridine ring to form a ring system containing a quinoline moiety.

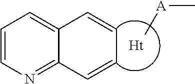

A pyridine ring can for example be annelated to a benzene ring to form a ring system containing a quinoline moiety in which the heterocyclic ring Ht, for example an oxazine ring, is fused to the pyridine ring

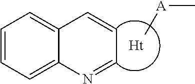

The aromatic ring can be annelated to a quinone ring to form a naphthoquinoid or anthraquinoid structure. In an alkoxysilane of the formula

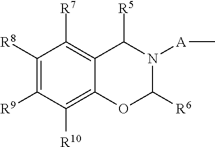

the groups R⁸ and R⁹, R⁷ and R⁸, or R⁹ and R¹⁰ can form an annelated ring of naphthoquinoid or anthraquinoid structure. Such ring systems containing carbonyl groups may form resins having improved solubility in organic solvents, allowing easier application to polymer compositions.

The organic group R_{N} containing nitrogen can alternatively comprise an aminoalkyl or aminoaryl group containing 1 to 20 carbon atoms and 1 to 3 nitrogen atoms bonded to a silicon atom of the silicone resin, for example —(CH₂)₃NH₂, —(CH₂)₄NH₂, —(CH₂)₃NH(CH₂)₂NH₂, —CH₂CH(CH₃)CH₂NH₂, —CH₂CH(CH₃)CH₂NH(CH₂)₂NH₂, —(CH₂)₃NHCH₂CH₂NH(CH₂)₂NH₂, —CH₂CH(CH₃)CH₂NH(CH₂)₃NH₂, —(CH₂)₃NH(CH₂)₄NH₂ or —(CH₂)₃O(CH₂)₂NH₂, or —(CH₂)₃NHC₆H₄, —(CH₂)₃NH(CH₂)₂NHC₆H₄, —(CH₂)₃NHCH₃, —(CH₂)₃N(C₆H₄)₂.

Optionally, the organic group contains both phosphorus and nitrogen. Preferably, the molar ratio of Metal atom to Si atom of the silicone resin ranges from 0.01:1 to 2:1. The invention further provides a method for the preparation of a silicone resin, wherein
a. A Metal M containing material which is preferably free of chlorine atoms,
b. A phosphorylated or nitrogenated alkoxysilane or hydroxysilane or alkoxysiloxane or hydroxysiloxane,
c. Optionally an alkoxysilane or hydroxysilane or alkoxysiloxane or hydroxysiloxane are hydrolysed and condensed to form metallosiloxane containing Si—O-M bonds optionally in the presence of an inorganic filler.

This process permits to avoid the use of chlorosilane as raw materials which imply the use of toxic pyridine as solvent, followed by a neutralization step of HCl as described in U.S. Pat. No. 6,716,952. Moreover when using raw materials containing chlorine, high risks to find chlorine left in the final product impeding obtaining desirable halogen free flame retardant compositions. U.S. Pat. No. 6,716,952 don't give any proofs of total absence of residual chlorine atoms in their final product.

In a possible synthesis approach, alkoxypolysiloxane or hydroxypolysiloxane resins can be used as raw material. A branched silicone resin of the invention containing at least one phosphonate or phosphinate moiety present in a T unit of the formula R_{P}SiO_{3/2} can for example be prepared by a process in which a trialkoxysilane of the formula R_{P}Si(OR′)₃ is hydrolysed and condensed with Metal M containing compound to form metallosiloxane bonds. Examples of useful trialkoxysilanes containing a R_{P} group are 2-(diethylphosphonato)ethyltriethoxysilane, 3-(diethylphosphonato)propyltriethoxysilane and 2-(DOPO)ethyltriethoxysilane.

A silicone resin of the invention containing at least one organic nitrogen-containing group present in a T unit of the formula R_{N}SiO_{3/2} can for example be prepared by a process in which a trialkoxysilane of the formula R_{N}Si(OR′)₃ is hydrolysed and condensed with Metal M containing compound to form metallosiloxane bonds. Examples of useful trialkoxysilanes containing a R_{N} group are 3-(3-benzoxazinyl)propyltriethoxysilane.

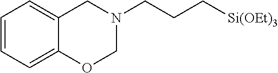

and the corresponding naphthoxazinetriethoxysilane,

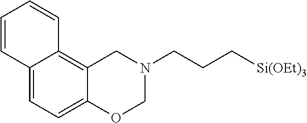

3-(6-cyanobenzoxazinyl-3)propyltriethoxysilane,

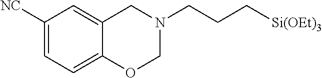

3-(2-phenylbenzoxazinyl-3)propyltriethoxysilane

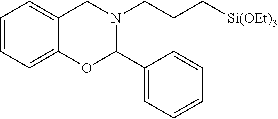

and 3-aminopropyltrimethoxysilane.

The branched silicone resin containing at least one organic nitrogen-containing group can be formed from a bis(alkoxysilane), for example a bis(trialkoxysilane), containing two heterocyclic rings each having an alkoxysilane substituent, such as 1,3-bis(3-(3-trimethoxysilylpropyl)benzoxazinyl-6)-2,2-dimethylpropane

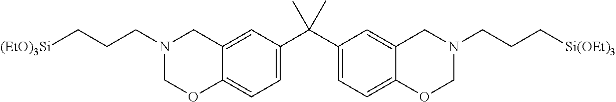

The silicone resin can in one preferred embodiment comprise mainly T units, that is at least 50 mole % T units, and more preferably at least 80 or 90% T units. It can for example comprise substantially all T units. The trialkoxysilanes or trihydroxysilane of the formulae R_{P}Si(OR′)₃ and R_{N}Si(OR′)₃ can be hydrolysed and condensed in the presence of a Metal M containing material, optionally with an hydroxysilane or alkoxysilane of the formula R⁴Si(OR′)₃, in which each R′ is an hydrogen, alkyl group having 1 to 4 carbon atoms and R⁴ represents a hydrogen, alkyl, cycloalkyl, aminoalkyl, alkenyl, alkynyl, aryl or aminoaryl group having 1 to 20 carbon atoms. Examples of useful alkoxysilanes of the formula R⁴Si(OR′)₃ are alkyltrialkoxysilanes such as methyltriethoxysilane, ethyltriethoxysilane, methyltrimethoxysilane, aryltrialkoxysilanes such as phenyltriethoxysilane and alkenyltrialkoxysilanes such as vinyltrimethoxysilane.

Alternative alkoxysilanes or hydroxysilane containing a phosphonate or phosphinate group are monoalkoxysilanes for example of the formula R_{P}R¹¹₂SiOR′ and dialkoxysilanes for example of the formula R_{P}R¹¹Si(OR′)₂, where each R′ is a hydrogen, alkyl group having 1 to 4 carbon atoms; each R_{P} is an alkyl, cycloalkyl, alkenyl, alkynyl or aryl group having 1 to 20 carbon atoms containing a phosphonate or phosphinate substituent; and each R¹¹ which can be the same or different is an alkyl, cycloalkyl, alkenyl, alkynyl or aryl group having 1 to 20 carbon atoms or an alkyl, cycloalkyl, alkenyl, alkynyl or aryl group having 1 to 20 carbon atoms containing a phosphonate or phosphinate substituent. Examples of suitable monoalkoxysilanes containing a phosphonate or phosphinate group are 2-(DOPO)ethyldimethylethoxysilane and 3-(diethylphosphonato)propyldimethylethoxysilane. Examples of suitable dialkoxysilanes containing a phosphonate or phosphinate group are 2-(DOPO)ethylmethyldiethoxysilane and 3-(diethylphosphonato)propylmethyldiethoxysilane.

Alternative alkoxysilanes or hydroxysilanes containing an organic nitrogen-containing group are monoalkoxysilanes for example of the formula R_{N}R¹²₂SiOR′ and dialkoxysilanes for example of the formula R_{N}R¹²Si(OR′)₂ where each R_{N} is an alkyl, cycloalkyl, alkenyl, alkynyl or aryl group having 1 to 20 carbon atoms containing an organic nitrogen substituent; and each R¹² which can be the same or different is an alkyl, cycloalkyl, alkenyl, alkynyl or aryl group having 1 to 20 carbon atoms or an alkyl, cycloalkyl, alkenyl, alkynyl or aryl group having 1 to 20 carbon atoms containing an organic nitrogen substituent. Examples of suitable monoalkoxysilanes containing an organic nitrogen substituent are 3-(3-benzoxazinyl)propyldimethylethoxysilane and 3-aminopropyldimethylethoxysilane. Examples of suitable dialkoxysilanes containing an organic nitrogen substituent are 3-(3-benzoxazinyl)propylmethyldiethoxysilane and 3-aminopropylmethyldimethoxysilane.

Monoalkoxysilanes or hydroxysilanes when hydrolysed and condensed will form M′ groups in the silicone resin and dialkoxysilanes when hydrolysed and condensed will form D groups in the silicone resin. A monoalkoxysilane or dialkoxysilane containing a R_{P} group can be reacted with trialkoxysilanes and/or tetraalkoxysilanes to form a branched silicone resin.

In preferred embodiment, the reactant is alkoxysiloxane or hydroxysilane or hydroxysiloxane. In a preferred embodiment where borosiloxane is formed, the Metal containing material is at least one boron containing material selected from (i) boric acid of the formula B(OH)3, any of its salts or boric anhydride, (ii) boronic acid of the formula R1B(OH)2, (iii) alkoxyborate of formula B(OR2)3 or R1B(OR2)2, a mixture containing at least two or more of (i), (ii) or (iii), where R1 and R2 are independently alkyl, alkenyl, aryl or arylalkyl substituents.

Preferably, the Metal containing material has the general formula M(R3)ₘ where m=1 to 7 depending on the oxidation state of the considered Metal, selected from alkoxymetals where R3=OR′ and R′ is an alkyl group, and metal hydroxyl where R3=OH. Metal chlorides where R3=Cl are to be avoided so as to guarantee that the product of the reaction is halogen free. When M is Al, the alkoxymetal can be for example (Al(OEt)3, Al(OiPr)3 or Al(OPr)3). Chlorine containing derivatives such as AlCl3 are to be avoided.

The optionally present alkoxysilane or hydroxysilane is preferably selected from i) tetra(alkoxysilane) Si(OR3)4, (ii) trialkoxysilane R6Si(OR3)3, (iii) dialkoxysilane R6R7Si(OR3)2 or (iv) monoalkoxysilane R6R7R8SiOR3, a mixture containing two or more of (i), (ii), (iii) or (iv), where R3 is a C1 to C10 alkyl group and R6, R7 and R8 are independently alkyl, alkenyl, aryl, arylalkyl, bearing or not organic functionalities such as but not limited to glycidoxy, methacryloxy, acryloxy, and R is an alkyl group. Example of suitable hydroxysilane is diphenyl(dihydroxy)silane.

Addition of water during the synthesis is possible but not required. Water loading are calculated minimum to consume partially the alkoxies and preferably the whole alkoxies present in the system. Preferably, the whole mixture is refluxed at a temperature preferably ranging from 50 to 160° C. in the presence or not of an organic solvent. Then the alcohol and organic solvent are stripped and possible remaining water are distilled off from the resin through, for example, azeotropic mixture water/alcohol.

These new phosphorylated or nitrogenated metallosiloxanes don't systematically require any condensation catalyst to condense, which represent an advantage in terms of processing as no filtration step is required to remove possible condensation catalyst from the media. In some preferred embodiments, a condensation catalyst is used during the synthesis to force/increase conversion. For example, HCl or Sn or Ti based catalytic systems can be used.

The obtained product can be further dried under vacuum at high temperature (ranging from 50 to 100° C.) to remove remaining traces of solvents, alcohols or water. These phosphorylated or nitrogenated metallosiloxanes demonstrate better heat stability compared to their non-metallised or non-phosphorylated or non-nitrogenated resins counterparts. These resins can be used as additives in polymers or coatings formulations to improve, for example, flame retardancy and/or scratch and/or abrasion resistance.

These new resins can be further blended with various thermoplastics or thermosets to make them flame retardant. The invention therefore extends to the use of the silicone resin in a thermoplastic or thermosetting organic polymer composition to reduce the flammability of the organic polymer composition. The invention allows a reduction of the emitted fumes upon burning compared to their non phosphorylated and/or non metalized counterparts. The invention keeps to a certain extent the transparency of the host matrix, i.e. the new resin allows to keep the transparency of the polymer it is blended with or the coating made up with the resin is transparent.

The silicone resins of the invention have a high thermal stability which is higher than that of their non-phosphorylated or non-nitrogenated counterparts and higher than that of linear silicone polymers. This higher thermal stability is due to the presence of the metal and phosphorus or nitrogen atom that leads to the formation of highly stable ceramic structures. Such silicone resins additionally undergo an intumescent effect on intense heating, forming a flame resistant insulating char.

The branched silicone resins of the invention can be blended with a wide range of thermoplastic resins, for example polycarbonates, ABS (acrylonitrile butadiene styrene) resins, polycarbonate/ABS blends, polyesters, polystyrene, or polyolefins such as polypropylene or polyethylene. The silicone resins of the invention can also be blended with thermosetting resins, for example epoxy resins of the type used in electronics applications, which are subsequently thermoset, or unsaturated polyester resin. The mixtures of thermoplastics or thermosets with the silicone resins of the invention as additives have been proved to have a low impact on Tg value and thermal stability, as shown by differential scanning calorimetry (DSC) and thermogravimetric analysis (TGA), and better flammability properties, as shown by UL-94 test, and/or other flammability tests such as the glow wire test or cone calorimetry, compared to their non phosphorylated counterparts. The branched silicone resins of the invention are particularly effective in increasing the fire resistance of polycarbonates and blends of polycarbonate with other resins such as polycarbonate/ABS blends.

The thermoplastic matrice can be chosen from the carbonate family (e.g. Polycarbonate PC), polyamides (e.g. Polyamide 6 and 6.6), polyester (e.g. polyethyleneterephtalate). The thermoplastic matrice can be chosen from the polyolefin family (e.g. polypropylene PP or polyethylene PE or polyethylene terephatalate PET). The thermoplastic matrice can be a bio-sourced thermoplastic matrice such as polylactic acid (PLA) or polyhydroxybutadiene (PHB) or bio-sourced PP/PE. The matrice can be polybutylene terephtalate (PBT). The matrice can be chosen from thermoplastic/rubbers blends from the family of PC/Acrylonitrile/styrene/butadiene ABS. The matrice can be chosen from rubber made of a diene, preferably natural rubber. The matrice can be chosen from thermoset from the Novolac family (phenol-formol) or epoxy. These above polymers can optionally be reinforced with, for example, glass fibres.

In a preferred embodiment of the invention, the siloxane resin is introduced in the monomer so as to provide after polymerisation a copolymer having Si—O-M bonds. The resin can for example be end-capped with Eugenol to provide terminal-OH bonds. The modified resin can then be reacted with bisphenol-A and phosgene to provide a Si—O-M-PC polymer.

Applications include but are not limited to transportation vehicles, construction, electrical application, printed circuits boards and textiles. Unsaturated polyester resins, or epoxy are moulded for use in, for example, the nacelle of wind turbine devices. Normally, they are reinforced with glass (or carbon) fibre cloth; however, the use of a flame retardant additive is important for avoiding fire propagation.

The silicone resins of the invention frequently have further advantages including but not limited to transparency, higher impact strength, toughness, increased adhesion between two surfaces, increased surface adhesion, scratch and/or abrasion resistance and improved tensile and flexural mechanical properties. The resins can be added to polymer compositions to improve mechanical properties such as impact strength, toughness and tensile, flexural mechanical properties and scratch and/or abrasion resistance. The resins can be used to treat reinforcing fibres used in polymer matrices to improve adhesion at the fibre polymer interface. The resins can be used at the surface of polymer compositions to improve adhesion to paints. The resins can be used to form coatings on a substrate.

The silicone resins of the invention can for example be present in thermoplastic or thermoset or rubber or thermoplastic/rubber blends organic polymer compositions in amounts ranging from 0.1 or 0.5% by weight up to 50 or 75%. Preferred amounts may range from 0.1 to 25% by weight silicone resin in thermoplastic compositions such as polycarbonates, and from 0.2 to 75% by weight in thermosetting compositions such as epoxy resins. The invention also provides the use of a silicone resin as defined herein above as a fire- or scratch- and/or abrasion resistant coating on a substrate.

The invention further provides a thermoplastic or thermoset or rubber or thermoplastic/rubber blends organic polymer composition comprising a thermoplastic or thermoset organic polymer and a silicone resin as defined herein above. The invention also provides a fire- or scratch and/or abrasion resistant coating on a substrate wherein the coating comprises a silicone resin as defined hereinabove.

In certain preferred embodiments, the silicone resin disclosed in the present patent can be used in conjunction with another flame retardant compound. Among the halogen-free flame retardants one can find the metal hydroxides, such as magnesium hydroxide (Mg(OH)₂) or aluminium hydroxide (Al(OH)₃), which act by heat absorbance, i.e. endothermic decomposition into the respective oxides and water when heated, however they present low flame retardancy efficiency, low thermal stability and significant deterioration of the physical/chemical properties of the matrices due to high loadings. Other compounds act mostly on the condensed phase, such as expandable graphite, organic phosphorous (e.g. phosphate, phosphonates, phosphine, phosphine oxide, phosphonium compounds, phosphites, etc.), ammonium polyphosphate, polyols, etc. Zinc borate, nanoclays and red phosphorous are other examples of halogen-free flame retardants synergists that can be combined with the silicone material disclosed in this patent. Silicon-containing additives such as silica, aluminosilicate or magnesium silicate (talc) are known to significantly improve the flame retardancy, acting mainly through char stabilization in the condensed phase. Silicone-based additives such as silicone gums are known to significantly improve the flame retardancy, acting mainly through char stabilization in the condensed phase. Sulfur-containing additives, such as potassium diphenyl sulfone sulfonate (known as KSS), are well known flame retardant additives for thermoplastics, in particular for polycarbonate but are only of high efficiency at reducing the dripping effect. In a preferred embodiment, the resin is used in conjunction with Zinc-Borate additive.

Either the halogenated, or the halogen-free compounds can act by themselves, or as synergetic agent together with the compositions claimed in the present patent to render the desired flame retardance performance to many polymer or rubber matrices. For instance, phosphonate, phosphine or phosphine oxide have been referred in the literature as being anti-dripping agents and can be used in synergy with the flame retardant additives disclosed in the present patent. The paper “Flame-retardant and anti-dripping effects of a novel char-forming flame retardant for the treatment of poly(ethylene terephthalate) fabrics” presented by Dai Qi Chen et al. at 2005 Polymer Degradation and Stability describes the application of a phosphonate, namely poly(2-hydroxy propylene spirocyclic pentaerythritol bisphosphonate) to impart flame retardance and dripping resistance to poly(ethylene terephthalate) (PET) fabrics. Benzoguanamine has been applied to PET fabrics to reach anti-dripping performance as reported by Hong-yan Tang et al. at 2010 in “A novel process for preparing anti-dripping polyethylene terephthalate fibres”, Materials & Design. The paper “Novel Flame-Retardant and Anti-dripping Branched Polyesters Prepared via Phosphorus-Containing Ionic Monomer as End-Capping Agent” by Jun-Sheng Wang et al. at 2010 reports on a series of novel branched polyester-based ionomers which were synthesized with trihydroxy ethyl esters of trimethyl-1,3,5-benzentricarboxylate (as branching agent) and sodium salt of 2-hydroxyethyl 3-(phenylphosphinyl)propionate (as end-capping agent) by melt polycondensation. These flame retardant additives dedicated to anti-dripping performance can be used in synergy with the flame retardant additives disclosed in this patent. Additionally, the flame retardant additives disclosed in the present patent have demonstrated synergy with other well-known halogen-free additives, such as Zinc Borates and Metal Hydroxydes (aluminium trihydroxyde or magnesium dihydroxyde) or polyols (pentaerythritol). When used as synergists, classical flame retardants such as Zinc Borates or Metal Hydroxydes (aluminium trihydroxyde or Magnesium dihydroxyde) can be either physically blended or surface pre-treated with the silicon based additives disclosed in this patent prior to compounding.

Therefore, preferably the thermoplastic or thermoset organic polymer composition according to the invention further comprises classical flame retardant additive such as but not limited to inorganic flame retardants such as metal hydrates or zinc borates, magnesium hydroxide, aluminum hydroxide, phosphorus and/or nitrogen containing additives such as ammonium polyphosphate, boron phosphate, carbon based additives such as expandable graphite or carbon nanotubes, nanoclays, red phosphorous, silica, aluminosilicates or magnesium silicate (talc), silicone gum, sulfur based additives such as sulfonate, ammonium sulfamate, potassium diphenyl sulfone sulfonate (KSS) or thiourea derivatives, polyols like pentaerythritol, dipentaerythritol, tripentaerythritol or polyvinylalcohol.

In addition, the resin of the present invention can be used with other additives commonly used as polymer fillers such as but not limited to talc, calcium carbonate. They can be powerful synergists when mixed with the additive described in the present patent. Examples of mineral fillers or pigments which can be incorporated in the polymer include titanium dioxide, aluminium trihydroxide, magnesium dihydroxide, mica, kaolin, calcium carbonate, non-hydrated, partially hydrated, or hydrated fluorides, chlorides, bromides, iodides, chromates, carbonates, hydroxides, phosphates, hydrogen phosphates, nitrates, oxides, and sulphates of sodium, potassium, magnesium, calcium, and barium; zinc oxide, aluminium oxide, antimony pentoxide, antimony trioxide, beryllium oxide, chromium oxide, iron oxide, lithopone, boric acid or a borate salt such as zinc borate, barium metaborate or aluminium borate, mixed metal oxides such as aluminosilicate, vermiculite, silica including fumed silica, fused silica, precipitated silica, quartz, sand, and silica gel; rice hull ash, ceramic and glass beads, zeolites, metals such as aluminium flakes or powder, bronze powder, copper, gold, molybdenum, nickel, silver powder or flakes, stainless steel powder, tungsten, hydrous calcium silicate, barium titanate, silica-carbon black composite, functionalized carbon nanotubes, cement, fly ash, slate flour, bentonite, clay, talc, anthracite, apatite, attapulgite, boron nitride, cristobalite, diatomaceous earth, dolomite, ferrite, feldspar, graphite, calcined kaolin, molybdenum disulfide, perlite, pumice, pyrophyllite, sepiolite, zinc stannate, zinc sulfide or wollastonite. Examples of fibres include natural fibres such as wood flour, wood fibres, cotton fibres, cellulosic fibres or agricultural fibres such as wheat straw, hemp, flax, kenaf, kapok, jute, ramie, sisal, henequen, corn fibre or coir, or nut shells or rice hulls, or synthetic fibres such as polyester fibres, aramid fibres, nylon fibres, or glass fibres. Examples of organic fillers include lignin, starch or cellulose and cellulose-containing products, or plastic microspheres of polytetrafluoroethylene or polyethylene. The filler can be a solid organic pigment such as those incorporating azo, indigoid, triphenylmethane, anthraquinone, hydroquinone or xanthine dyes.

### Phosphorylated Borosiloxane Synthesis and Flame Retardant

### EXAMPLES

DOPO-Silane refers to the following structure and is referred as T(DOPO):

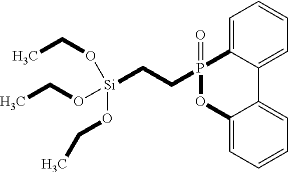

### Synthesis Procedure for the Synthesis of Borosiloxane T(DOPO)66B34 (Resin#1)

In a round bottomed flask equipped with a mechanical stirrer and a condenser, 30 gr (73.9 mmol, 1 eq) of DOPO-silane and 2.3 gr (36.9 mmol, 0.5 eq) of boric acid were mixed together and heated under gentle stirring at 130° C. Rapidly, reflux of ethanol was observed on the walls of the reactor due to the “hydrolysis-condensation” reaction of boric acid with the alkoxysilane. When reaching 130° C., the insoluble B(OH)3 powder disappeared due to its consumption in the resin. The reaction was heated at 130° C. for 60 minutes. Under gentle stirring, the solution was placed under vacuum (200 mbars) and the ethanol by-product was striped out from the reaction mixture. Vacuum was maintained until completion of the stripping to obtain a pasty intermediate material. The semi-solid was further stripped at 100 mbars for 30 minutes to afford a whitish solid. The whitish solid was crushed and further dried in a vacuum oven at 20 mbars and 85° C. for 12 hours. The resin was recovered as a fluffy whitish powder.

### Synthesis of Borosiloxane T(DOPO)50B50 (Resin#2)

In a round bottomed flask equipped with a mechanical stirrer and a condenser, 20 gr (49 mmol, 1 eq) of DOPO-silane and 3.7 gr (59 mmol, 1.2 eq) of boric acid were mixed together and heated under gentle stirring at 130° C. Rapidly, reflux of ethanol was observed on the walls of the reactor due to the “hydrolysis-condensation” reaction of boric acid with the alkoxysilane. When reaching 130° C., the insoluble B(OH)3 powder disappeared due to its consumption in the resin. The reaction was heated at 130° C. for 60 minutes. Under gentle stirring, the solution was placed under vacuum (200 mbars) and the ethanol by-product was striped out from the reaction mixture. Vacuum was maintained until completion of the stripping to obtain a pasty intermediate material. The semi-solid was further stripped at 100 mbars for 30 minutes to afford a whitish solid. The whitish solid was crushed and further dried in a vacuum oven at 20 mbars and 85° C. for 12 hours. The resin was recovered as a fluffy whitish powder.

### Synthesis of Borosiloxane T(DOPO)34B66 (Resin#3)

In a round bottomed flask equipped with a mechanical stirrer and a condenser, 30 gr (73.9 mmol, 1 eq) of DOPO-silane and 9.1 gr (147.8 mmol, 2 eq) of boric acid were mixed together and heated under gentle stirring at 130° C. Rapidly, reflux of ethanol was observed on the walls of the reactor due to the “hydrolysis-condensation” reaction of boric acid with the alkoxysilane. When reaching 130° C., the insoluble B(OH)3 powder disappeared due to its consumption in the resin. The reaction was heated at 130° C. for 60 minutes. Under gentle stirring, the solution was placed under vacuum (200 mbars) and the ethanol by-product was striped out from the reaction mixture. Vacuum was maintained until completion of the stripping to obtain a pasty intermediate material. The semi-solid was further stripped at 100 mbars for 30 minutes to afford a whitish solid. The whitish solid was crushed and further dried in a vacuum oven at 20 mbars and 85° C. for 12 hours. The resin was recovered as a fluffy whitish powder.

### Synthesis of Borosiloxane T(DOPO)33.3T(Ph)33.3B33.3 (Resin#4)

In a round bottomed flask equipped with a mechanical stirrer and a condenser, 20 gr (49.3 mmol, 1 eq) of DOPO-silane, 9.7 gr of phenyltrimethoxysilane (49.3 mmol, 1 eq) and 3 gr (49.3 mmol, 1 eq) of boric acid were mixed together and heated under gentle stirring at 130° C. Rapidly, reflux of ethanol was observed on the walls of the reactor due to the “hydrolysis-condensation” reaction of boric acid with the alkoxysilane. When reaching 130° C., the insoluble B(OH)3 powder disappeared due to its consumption in the resin. The reaction was heated at 130° C. for 60 minutes. Under gentle stirring, the solution was placed under vacuum (200 mbars) and the ethanol by-product was striped out from the reaction mixture. Vacuum was maintained until completion of the stripping to obtain a pasty intermediate material. The semi-solid was further stripped at 100 mbars for 30 minutes to afford a whitish solid. The whitish solid was crushed and further dried in a vacuum oven at 20 mbars and 85° C. for 12 hours. The resin was recovered as a fluffy whitish powder.

### Synthesis of Borosiloxane T(DOPO)25T(Ph)25B50 (Resin#5)

In a round bottomed flask equipped with a mechanical stirrer and a condenser, 20 gr (49.3 mmol, 1 eq) of DOPO-silane, 9.7 gr of phenyltrimethoxysilane (49.3 mmol, 1 eq) and 6.1 gr (98.5 mmol, 2 eq) of boric acid were mixed together and heated under gentle stirring at 130° C. Rapidly, reflux of ethanol was observed on the walls of the reactor due to the “hydrolysis-condensation” reaction of boric acid with the alkoxysilane. When reaching 130° C., the insoluble B(OH)3 powder disappeared due to its consumption in the resin. The reaction was heated at 130° C. for 60 minutes. Under gentle stirring, the solution was placed under vacuum (200 mbars) and the ethanol by-product was striped out from the reaction mixture. Vacuum was maintained until completion of the stripping to obtain a pasty intermediate material. The semi-solid was further stripped at 100 mbars for 30 minutes to afford a whitish solid. The whitish solid was crushed and further dried in a vacuum oven at 20 mbars and 85° C. for 12 hours. The resin was recovered as a fluffy whitish powder.

### Synthesis of Borosiloxane T(DOPO)16.7T(Ph)16.7B66.6 (Resin#6)

In a round bottomed flask equipped with a mechanical stirrer and a condenser, 20 gr (49.3 mmol, 1 eq) of DOPO-silane, 9.7 gr of phenyltrimethoxysilane (49.3 mmol, 1 eq) and 12.2 gr (197 mmol, 4 eq) of boric acid were mixed together and heated under gentle stirring at 130° C. Rapidly, reflux of ethanol was observed on the walls of the reactor due to the “hydrolysis-condensation” reaction of boric acid with the alkoxysilane. When reaching 130° C., the insoluble B(OH)3 powder disappeared due to its consumption in the resin. The reaction was heated at 130° C. for 60 minutes. Under gentle stirring, the solution was placed under vacuum (200 mbars) and the ethanol by-product was striped out from the reaction mixture. Vacuum was maintained until completion of the stripping to obtain a pasty intermediate material. The semi-solid was further stripped at 100 mbars for 30 minutes to afford a whitish solid. The whitish solid was crushed and further dried in a vacuum oven at 20 mbars and 85° C. for 12 hours. The resin was recovered as a fluffy whitish powder.

All resins compositions are gathered in the table 1 below.

TABLE 1

| | Resin composition (Mol %) | | |
|---|---|---|---|
| Si-Resin # | T(DOPO) | T(Ph) | B |
| 1 | 66 | | 34 |
| 2 | 50 | | 50 |
| 3 | 34 | | 66 |
| 4 | 33.3 | 33.3 | 33.3 |
| 5 | 25 | 25 | 50 |
| 6 | 16.7 | 16.7 | 66.6 |
| 7 | | 100 | |
| 8 | | 50 | 50 |

Resins 1 to 6 represent the examples for the phosphorylated borosiloxanes with increasing boron content from 1 to 3 and from 4 to 6. Resin#7 represent a pure commercial T(Ph) silicone resin (Dow Corning®217 flake resin) without phosphorus and boron in the structure. Resin#8 represents a non phosphorylated phenyl borosiloxane. This last resin was prepared following the procedure described to prepare resins 1 to 6 above. Comparative examples C1: This example is a commercially available pure T(Ph) resin. This example is related to a pure silicon containing resin. Comparative examples C2: this example is represented by a non-phosphorylated borosiloxane resin.

All samples were prepared following the protocol described in table 2 below:

TABLE 2

| | Time |
|---|---|
| Material to introduce | (min) |
| Chamber T° 270° C., Blade at 50 rotations per minute - | 0.0 |
| add ⅓ of PC resin and close ramp | |
| Add ⅓ of PC resin and after the peak torque | 2.0 |
| close the ramp | |
| Add the Si-based material, close the ramp and set | 3.0 |
| the temperature to 260° C. | |
| Add ⅓ of PC resin, set the rotation to 70 RPM | 4.0 |
| and leave the ramp open | |
| close the ramp | 5.0 |
| Drop Batch | 7.0 |

Material was compression moulded into 100×100×3 mm plates. These plates were used to run thermal characterization as cone calorimeter test.

TABLE 3
Formulation

| | | Loadings | | | | |
|---|---|---|---|---|---|---|
| Exam- | Res- | (weight | Polycarbonate | | | |
| ple# | ins | %) | (weight %) | P % | Si % | B % |
| 1 | 1 | 5 | 95 | 0.016 | 0.016 | 0.008 |
| 2 | 2 | 5.25 | 94.75 | 0.016 | 0.016 | 0.016 |
| 3 | 3 | 5.75 | 94.25 | 0.016 | 0.016 | 0.031 |
| 4 | 4 | 5 | 95 | 0.011 | 0.022 | 0.011 |
| 5 | 5 | 5.35 | 94.65 | 0.011 | 0.022 | 0.022 |
| 6 | 6 | 6.05 | 93.95 | 0.011 | 0.022 | 0.043 |
| Comparative | 7 | 5 | 95 | N.A. | 0.022 | 0.022 |
| C1 (simple | | | | | | |
| borosiloxane) | | | | | | |
| Comparative | 8 | 5 | 95 | N.A. | 0.022 | N.A. |
| C2 (pure | | | | | | |
| silicone resin) | | | | | | |
| Comparative | N.A. | N.A. | 100 | N.A. | N.A. | N.A. |
| C3 (Neat PC) | | | | | | |

Flame retardant results are gathered in the table 4 below

TABLE 4
Flame retardant results following ISO5660 norm at a 50 kW/m2 irradiation heat flux

| | | | Cone Calorimeter test | | | | | | |
|---|---|---|---|---|---|---|---|---|---|
| | | | ISO 5660 norm @ 50 kW/m2 heat flux | | | | | | Fume |
| | | | | | | | MAHRE | Weight | Density |
| Exam- | Resin | Tg | | | Total | | Time of | Loss | (ISO5659- |
| ple# | # | (° C.) | MAHRE | pKHR | HRR | ti | appearance | rate | 2) |
| 1 | 1 | 146 | 218 | 346 | 90 | 53 | 240 | 6.8 | N.M |
| 2 | 2 | 147 | 158 | 244 | 78 | 61 | 345 | 6.7 | N.M |
| 3 | 3 | 146 | 150 | 242 | 79 | 63 | 370 | 8.4 | 570 |
| 4 | 4 | 147 | 185 | 325 | 83 | 59 | 260 | 5.8 | N.M |
| 5 | 5 | 147 | 156 | 262 | 81 | 63 | 340 | 6.3 | N.M |
| 6 | 6 | 148 | 142 | 268 | 75 | 58 | 380 | 5.2 | 446 |
| C1 | 7 | N.M | 235 | 414 | 115 | 58 | 265 | 6.7 | N.M |
| C2 | 8 | N.M | 228 | 470 | 106 | 58 | 235 | 5 | N.M |
| C3 | N.A. | 151 | 250 | 430 | 95 | 61 | 245 | 13.8 | 1320 |

N.M = not measured.
MAHRE = Maximum Average of Heat Release Emission
pKHR = peak of Heat Release
Total HRR = Total Heat Release Rate
ti = Time to ignition

FIG. 1: Heat Release Rate Curves at 50 kW/m2 Heat Flux Obtained Following ISO 5660Norm.

As demonstrated in the table 1 and exemplified by heat release rate curves from FIG. 1; flame retardancy behaviour of polycarbonate was dramatically enhanced by the addition of 5-6 wt % of the phosphorylated borosiloxane resins. This was particularly true for examples 2-3 and 5-6. A clear correlation between boron content in the resin was established, also correlated with higher condensation levels of the silicone resins. Moreover, the new additives were found to be very powerful at reducing the fume density by 50-60% compared to the neat polycarbonate.

Moreover, counter examples C1 and C2 corresponding to a non phosphorylated borosiloxane and a pure phenylated silicone resin)(T(Ph)¹⁰⁰ clearly demonstrate the benefit of introducing phosphorus atoms directly in the borosiloxane resin structure.

For information, MAHRE (t), the Maximum Average Rate of Heat Release Emission at time t, is defined as the cumulative heat emission per unit area of exposed specimen, from t=0 to t=t, divided by t. MAHRE is the maximum value of AHRE during that period of time.

### Amino-Phosphorylated Borosiloxane Synthesis and Flame Retardant

### Examples

MeOBz-Silane refers to the following structure and is referred as T(MeOBz):

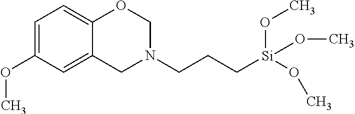 [SMILES: COc1ccc2c(c1)CN(CCC[Si](OC)(OC)OC)CO2]

### Synthesis of Amino-Phosphorylated Borosiloxane T(DOPO)28T(MeOBz)8T(Ph)7Q7B50 (Resin#9)

In a round bottomed flask equipped with magnetic stirrer and a condenser, 26.4 gr (65 mmol, 1 eq) DOPO silane, 6.84 gr (18.5 mmol, 0.28 eq) MeOBz-silane, 3.2 gr (16.1 mmol, 0.24 eq) phenyl trimethoxy silane, 3.4 gr of tetraethoxysilane (16.1 mmol, 0.24 eq) and 7.5 gr (121 mmol, 1.86 eq) boric acid were mixed together. The solution was heated up to 85° C. for 30 minutes. Rapidly, reflux of ethanol/methanol was observed on the walls of the reactor due to the “hydrolysis-condensation” reaction of boric acid with the alkoxysilane. When reaching 85° C., the insoluble B(OH)3 powder disappeared due to its consumption in the resin. Temperature was raised to 95° C. for 30 minutes and finally 110° C. for a further 30 minutes. Under gentle stirring, the solution was placed under vacuum (200 mbars) and the ethanol/methanol by-products were striped out from the reaction mixture. Vacuum was maintained until completion of the stripping to obtain a pasty intermediate material. The semi-solid was further stripped at 100 mbars for 30 min to afford a yellowish solid. The yellowish solid was crushed and further dried in a vacuum oven at 20 mbars and 95° C. for 2 hours. The resin was recovered as a fluffy yellowish powder.

### Synthesis of Amino-Phosphorylated Borosiloxane T(DOPO)28T(MeOBz)8Q14B50 (Resin#10)

In a round bottomed flask equipped with magnetic stirrer and a condenser, 27.4 gr (67 mmol, 1 eq) DOPO silane, 7.1 gr (19.2 mmol, 0.28 eq) MeOBz-silane, 7 gr of tetraethoxysilane (33.6 mmol, 0.5 eq) and 7.4 gr (120 mmol, 1.8 eq) boric acid were mixed together. The solution was heated up to 85° C. for 30 minutes. Rapidly, reflux of ethanol/methanol was observed on the walls of the reactor due to the “hydrolysis-condensation” reaction of boric acid with the alkoxysilane. When reaching 85° C., the insoluble B(OH)3 powder disappeared due to its consumption in the resin. Temperature was raised to 95° C. for 30 minutes and finally 110° C. for a further 30 minutes. Under gentle stirring, the solution was placed under vacuum (200 mbars) and the ethanol/methanol by-products were striped out from the reaction mixture. Vacuum was maintained until completion of the stripping to obtain a pasty intermediate material. The semi-solid was further stripped at 100 mbars for 30 min to afford a yellowish solid. The yellowish solid was crushed and further dried in a vacuum oven at 20 mbars and 95° C. for 2 hours. The resin was recovered as a fluffy yellowish powder.

All samples were prepared following the protocol described in table 2. Material was compression moulded into 100×100×3 mm plates. These plates were used to run thermal characterization as cone calorimeter test.

TABLE 5
Formulation

| | | Load- | Polycar- | | | | |
|---|---|---|---|---|---|---|---|
| | | ings | bonate | | | | |
| Exam- | Res- | (weight | (weight | | | | |
| ple# | ins # | %) | %) | P % | N % | Si % | B % |
| 7 | 9 | 2.5 | 97.5 | 0.005 | 0.0015 | 0.005 | 0.009 |
| 8 | 9 | 5 | 95 | 0.01 | 0.003 | 0.01 | 0.018 |
| 9 | 10 | 2.7 | 97.3 | 0.006 | 0.0017 | 0.006 | 0.011 |
| 10 | 10 | 5.4 | 94.7 | 0.0118 | 0.0034 | 0.012 | 0.021 |
| Comparative | 7 | 5 | 95 | N.A. | 0.022 | 0.022 | |
| C1 (simple | | | | | | | |
| boro- | | | | | | | |
| siloxane) | | | | | | | |
| Comparative | 8 | 5 | 95 | N.A. | N.A. | 0.022 | N.A. |
| C2 (pure | | | | | | | |
| silicone | | | | | | | |
| resin) | | | | | | | |
| Comparative | N.A. | N.A. | 100 | N.A. | N.A. | N.A. | N.A. |
| C2 (Neat | | | | | | | |
| PC) | | | | | | | |

Flame retardant results:

TABLE 6
Flame retardant results following ISO5660
norm at a 50 kW/m2 irradiation heat flux.

| | Cone Calorimeter test | | | | | |
|---|---|---|---|---|---|---|
| | ISO 5660 norm @ 50 kW/m2 heat flux | | | | | |
| Exam- | | | | | MAHRE | Weight |
| ple | | | Total | | time of | loss |
| # | MAHRE | pKHR | HRR | ti | appearance | rate |
| 7 | 194 | 340 | 93 | 63 | 295 | 6.3 |
| 8 | 179 | 358 | 93 | 63 | 320 | 5.7 |
| 9 | 196 | 346 | 91 | 61 | 305 | 5.7 |
| 10 | 167 | 300 | 86 | 65 | 335 | 5.4 |
| C1 | 235 | 414 | 115 | 58 | 265 | 6.7 |
| C2 | 228 | 470 | 106 | 58 | 235 | 5 |
| C3 | 250 | 430 | 95 | 61 | 245 | 13.8 |

MAHRE = Maximum Average of Heat Release Emission
pKHR = peak of Heat Release
Total HRR = Total Heat Release Rate
ti = Time to ignition

It is demonstrated in the table 6 above that the use of aminophosphorylated silicone of the present invention are also effective at reducing the MAHRE and pkHRR compared to neat PC but also compared to borosiloxane or a classical silicone resin (C3-1 and -2 example respectively). Increasing the amount of resin content was also increasing the fire retardancy behaviour. Decrease in the MAHRE value could be attributed to the formation of a stabilized char on the surface of the sample. Moreover, no influence on the time to ignition (ti) was observed with our new additives.

### Phosphorylated Borosiloxane Synergies with Classical Flame Retardant

Diethylphosphite(ethyltriethoxysilane)silane refers to the following structure and is referred as T(PO3Et2):

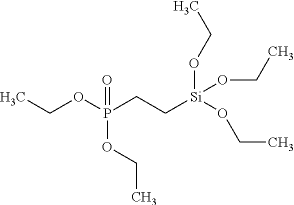 [SMILES: CCO[Si](CCP(=O)(OCC)OCC)(OCC)OCC]

### Synthesis of Amino-Phosphorylated Borosiloxane T(PO3Et2)25T(Ph)25B50 (Resin#11)

In a round bottomed flask equipped with magnetic stirrer and a condenser, 75 gr (228.7 mmol, 1 eq) diethylphosphite(ethyltriethoxysilane)silane, 45.3 gr phenyltrimethoxy silane (228.7 mmol, 1 eq) and 28.3 gr (457.3 mmol, 2 eq) boric acid were mixed together and heated under gentle stirring at 130° C. Rapidly, reflux of ethanol was observed on the walls of the reactor due to the “hydrolysis-condensation” reaction of boric acid with the alkoxysilane. When reaching 130° C., the insoluble B(OH)3 powder disappeared due to its consumption in the resin. The reaction was heated at 130° C. for 60 minutes. Under gentle stirring, the solution was placed under vacuum (200 mbars) and the ethanol by-product was striped out from the reaction mixture. Vacuum was maintained until completion of the stripping to obtain a pasty intermediate material. The semi-solid was further stripped at 100 mbars for 30 minutes to afford a whitish solid. The whitish solid was crushed and further dried in a vacuum oven at 20 mbars and 85° C. for 12 hours. The resin was recovered as a fluffy whitish powder.

TABLE 7
Formulation and Results

| | | | Zinc | | | | |
|---|---|---|---|---|---|---|---|
| | | | Borate | Cone Calorimeter test | | | |
| | | Resin | (FireBrake | ISO 5660 norm @ | | | |
| | | load- | 415) | 50 kW/m2 heat flux | | | |
| Exam- | Res- | ing | loading | | | Total | |
| ple# | in # | (wt %) | (wt %) | MAHRE | pKHR | HRR | ti |
| 11 | 11 | 5 | / | 235 | 356 | 114 | 48 |
| 12 | / | / | 10 | 214 | 312 | 95 | 49 |
| 13 | 11 | 5 | 10 | 164 | 308 | 115 | 45 |
| Compar- | / | / | / | 250 | 430 | 95 | 61 |
| ative | | | | | | | |
| C1 | | | | | | | |
| (neat PC) | | | | | | | |

As demonstrate in the table 7 above, introduction of the diethylphosphite based borosiloxane doesn't seem to show tremendous effect when used alone (example 1). The same trend is observed for Zinc Borate used alone (Example 2). However, the combination of both additives together showed a synergy with a decreased MAHRE value by 34% compared to neat PC.

Other synergies with classical flame retardant were identified for anti-dripping effect. The examples are gathered in the table 8 below.

TABLE 8

| | | | | UL-94 Vertical | |
|---|---|---|---|---|---|
| | | | Talc | Burning Test | |
| | | | (Luzenac | (1.5 mm thickness) | |
| | | Resin | OXO) | Total burning | |
| | | loading | loading | time (t1 + t2) | V classi- |
| Example# | Resin # | (wt %) | (wt %) | in sec | fication |
| 14 | 5 | 5 | / | 13 | Fail |
| 15 | / | / | 5 | 155+ | Fail |
| 16 | 5 | 5 | 5 | 28 | V-0 |
| Comparative | / | / | / | 38 | Fail |
| C1 (neat PC) | | | | | |

As demonstrated in the table 8 above and as stated in the present patent, the new phosphorylated resins showed good flame retardant synergies with other flame retardant additives such as magnesium silicates (e.g. talc). The combination of 5 wt % talc in combination with the resin #5 (used at a 5 wt % loading) was able to reach the UL-94 V0 rating (example 3).

### Optimized Synthesis of Borosiloxane T(DOPO)25T(Ph)25B50.

In a round bottomed flask equipped with a mechanical stirrer and a condenser, 50 gr (123 mmol, 1 eq) of DOPO-silane, 24.4 gr of phenyltrimethoxysilane (123 mmol, 1 eq) and 15.2 gr (246 mmol, 2 eq) of boric acid were mixed together with 2.6 ml of a 1M HCl solution (0.5 eq water+1% eq HCl) and heated under gentle stirring at 130° C. Rapidly, reflux of ethanol was observed on the walls of the reactor due to the “hydrolysis-condensation” reaction of boric acid with the alkoxysilane. When reaching 130° C., the insoluble B(OH)3 powder disappeared due to its consumption in the resin. The reaction was heated at 130° C. for 60 minutes. Under gentle stirring, the solution was placed under vacuum (200 mbars) and the ethanol by-product was striped out from the reaction mixture. Vacuum was maintained until completion of the stripping to obtain a pasty intermediate material. The semi-solid was further stripped at 100 mbars for 30 minutes to afford a whitish solid. The whitish solid was crushed and further dried in a vacuum oven at 20 mbars and 85° C. for 12 hours. The resin was recovered as a fluffy whitish powder. (Mw=2700, in THF, based on UV detection and PS references; residual boric acid=0.6 wt %, measured by GPC after boric acid derivatization with iPa).

### Abrasion Tests on Coated Wood and Polycarbonate

Silicon-Boron (Si—B—P) and Silicon-Aluminium (Si—Al—P) resins were synthesized and incorporated inside polymeric matrixes such as polycarbonates (PC). The abrasion resistance of moulded polycarbonate plates incorporating the resins was evaluated.

### Results

### Polycarbonate Plates

The mixtures Polycarbonate with Si—B—P or Si—Al—P were realized by thermoplastic mixer Brabender: 5.35% of Si—B—P/Si—Al—P resin (powder shape) were dry blended in the polycarbonate beads at 260° C. The blends were then heated (250° C.) and pressed (100 bars) to form square plates of 10×10 cm² and 3 mm thick.

Si—B—P polymer T_{dopo}²⁵T_{Ph}²⁵B⁵⁰

Si—Al—P polymer=T_{dopo}³⁰T_{Ph}⁵⁰Al²⁰

Polycarbonate=commercial grade, sold under brand name Polycarbonate Lexan 103 grade from SABIC.

The abrasive tests were realized on a Taber Abraser 5131, using H18 abrasive wheels, 1000 g on each wheel. Weight was measured after determined number of rotations of the sample below the wheels. The loss of weight was evaluated in function of rotations.

| | rotations | 0 | 50 | 500 | 1000 | 1500 | 3500 |
|---|---|---|---|---|---|---|---|
| Non modified | Weight | 34.008 | 33.9939 | 33.9513 | 33.928 | 33.9193 | 33.8926 |
| PC | Weight | 0.0 | −0.0141 | −0.0567 | −0.08 | −0.0887 | −0.1154 |
| | loss | | | | | | |
| PC + Si—B | Weight | 35.9741 | 35.9704 | 35.941 | 35.924 | 35.9053 | 35.8777 |
| | Weight | 0.0 | −0.0037 | −0.0331 | −0.0501 | −0.0688 | −0.0964 |
| | loss | | | | | | |
| PC + Si—Al | Weight | 18.0773 | 18.074 | 18.0488 | 18.0383 | 18.0309 | 18.0089 |
| | Weight | 0.0 | −0.0033 | −0.0285 | −0.039 | −0.0464 | −0.0684 |
| | loss | | | | | | |

On the graph of FIG. 2 plotting the weight loss in function of rotations, the unmodified PC (reference) was presenting a lower abrasion resistance compared to the 2 mixtures. When mixed in PC, Si—Al—P resin did sensitively improve the level of scratch resistance of the plate up to 40% compared to the unmodified reference. Si—B—P resin did improve the scratch resistance to approx. 17% compared to reference.

A 16% w solution of a Si Al P resin of composition T_{dopo}¹⁵T_{Ph}⁶⁵Al²⁰ in methylisobutyl ketone MIBK was prepared. A varnish formulation was prepared, in which slip additive DC 205SL and the Si Al P solution were added. Worlee C743 is a hydroxyfunctional polyester alkyde and Cymel303 is a crosslinking agent.

| Common | | | | | | |
|---|---|---|---|---|---|---|
| cmp. | parts | Sample # | 15A | 15A+ | 15B | 15B+ |
| Worlée C743 | 70.4 | Addition of: | | | | |
| Cymel 303 | 14 | DC 205SL additive | 0.5% | 0.5% | 0% | 0% |
| PMA | 6 | Solution SiAl | — | 2.1% | — | 2.1% |
| Butyl Acetate | 6 | | | | | |

The paints were applied on aluminium panels and cured at 150° C. for 10 minutes. Dry film thickness DFT was ˜40 μm. The abrasion resistance was evaluated with Taber Abraser equipment (model ref. 5131), using CS17 wheels, with 1000 g on each. Weight is measured after determined number of rotations of the sample below the wheels. The loss of weight in function of rotations (rounds) was evaluated.

### Results

### 1. 15B—No Slip Additive

The weight losses are shown in the table below. The graph shows obviously that better abrasion resistance is observed with the varnish incorporating the Si Al P polysiloxane.

### 2. 15A—0.5% Slip Additive

Same conclusion than for samples 15B. No effect of slip additive on scratch resistance.
Losses of weight for 15A/15B and 15A/15Bare similar.

| rounds | 0 | 500 | 1000 |
|---|---|---|---|
| 0.5% 205SL | 16.6843 | 16.6051 | 16.5532 |
| weight loss | 0.000 | −0.0792 | −0.1311 |
| 0.5% 205SL + 2% | 16.86445 | 16.8071 | 16.7752 |
| Si—Al | | | |
| weight loss | 0.000 | −0.05735 | −0.08925 |
| 0% 205SL | 16.7039 | 16.6352 | 16.5708 |
| weight loss | 0.000 | −0.0687 | −0.1331 |
| 0% 205SL + 2% | 16.4397 | 16.3844 | 16.3517 |
| Si—Al | | | |
| weight loss | 0.000 | −0.0553 | −0.0880 |

The two graphs of FIGS. 3 and 4 are similar, showing that Si Al P additives behave the same in the paint: the increase of scratch/abrasion resistance by the use of Si Al P polysiloxanes in these paints is about ˜30%. Furthermore, the slip additive 250SL has no effect on the scratch resistance.

### BRIEF DESCRIPTION OF THE DRAWINGS

Other advantages of the present invention will be readily appreciated, as the same becomes better understood by reference to the following detailed description when considered in connection with the accompanying drawing(s) wherein:

FIG. 1 is a graph as described above;

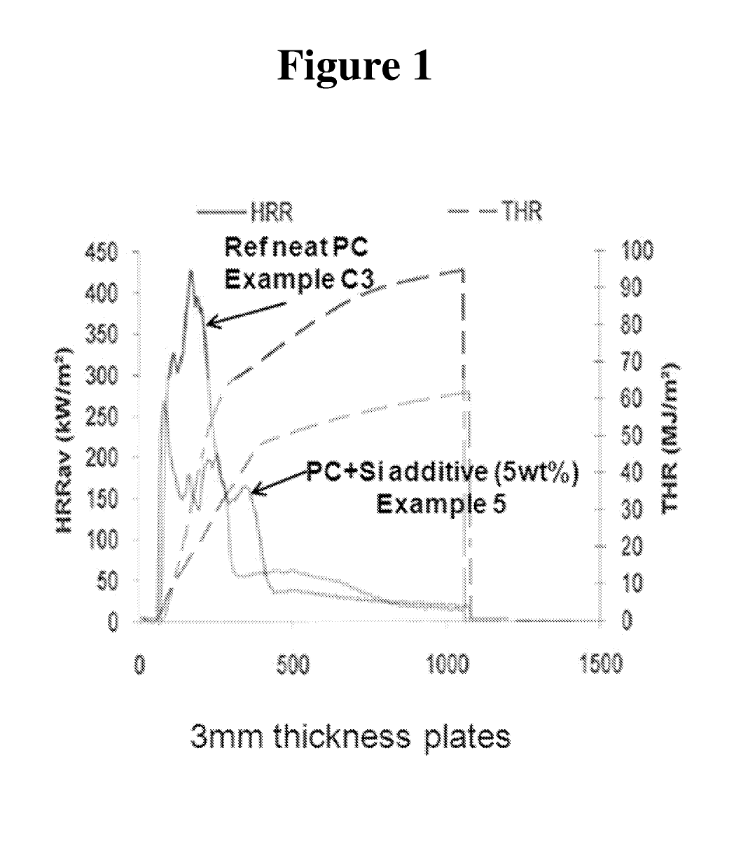

FIG. 2 is a graph as described above;

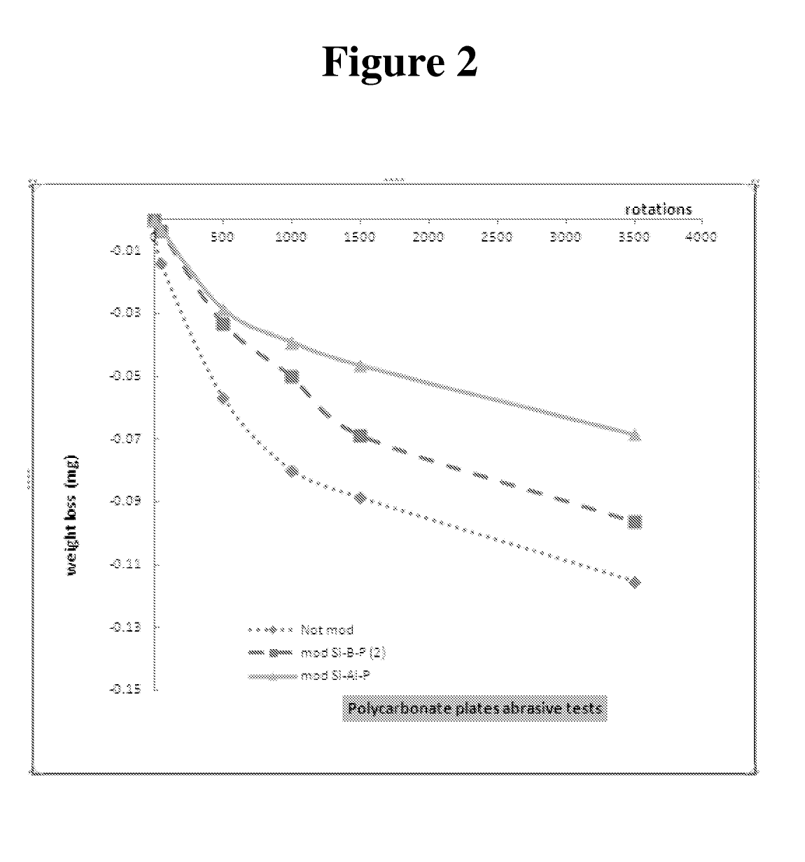

FIG. 3 is a graph as described above; and

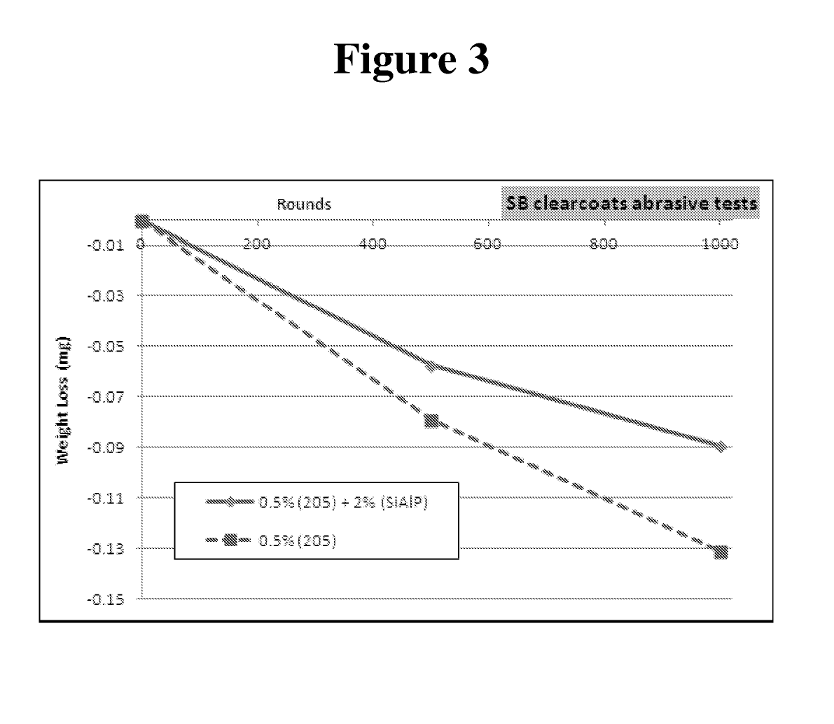

FIG. 4 is a graph as described above.

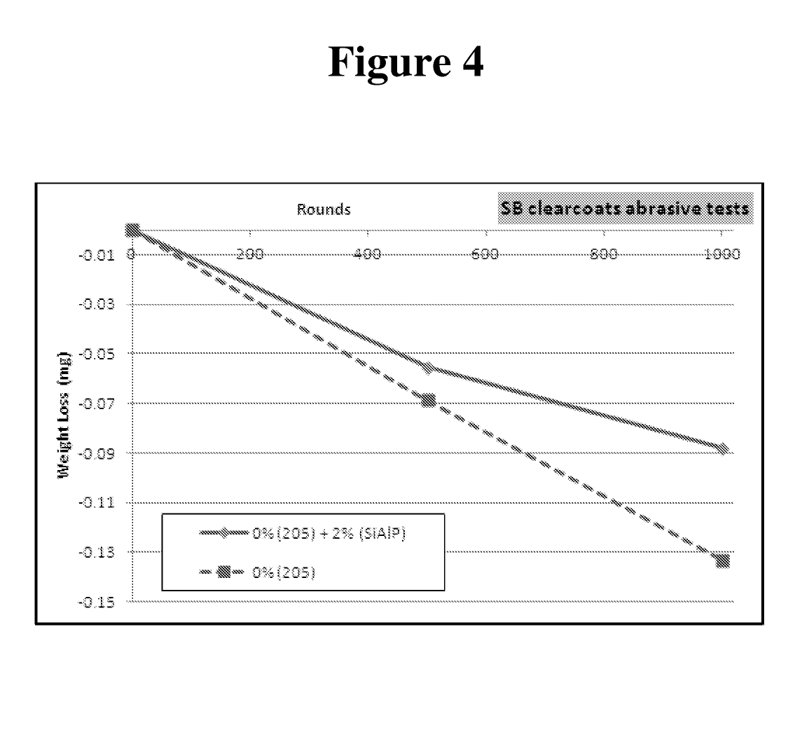

1. A silicone resin comprising:
a. at least one metallosiloxane comprising Si—O-M bonds, wherein Metal M is chosen from Transition Group metals, IIIA Group elements, Zr and Sn; and
b. at least one organic group comprising phosphorus and/or nitrogen with the proviso that when the Metal M is Al, the organic group is different than —(CH₂)₃NH₂,
c. wherein, when present, phosphorous is linked to Si through carbon atom(s).

2. The silicone resin according to claim 1 which contains T units; D units; M″ units and/or Q units.

3. The silicone resin according to claim 1 wherein the Metal M is boron, aluminum, titanium, tin or any mixture thereof.

4. The silicone resin according to claim 1, comprising at least one organic group containing phosphorus.

5. The silicone resin according to claim 4 wherein the resin contains at least one phosphine and/or phosphine oxide and/or phosphinate and/or phosphinite and/or phosphonite and/or phosphate and/or phosphonate, and/or a phosphate moiety present in a M unit of the formula RPR2SiO1/2 and/or a D unit of the formula RPRSiO2/2 and/or a T unit of the formula RPSiO3/2, where RP is an alkyl, cycloalkyl, alkenyl, alkynyl or aryl group having 1 to 20 carbon atoms containing a phosphine and/or phosphine oxide and/or phosphinate and/or phosphinite and/or phosphonite and/or phosphate and/or phosphonate, and/or a phosphate substituent, and each group R is independently an alkyl, cycloalkyl, alkenyl, alkynyl or aryl group having 1 to 20 carbon atoms.

6. The silicone resin according to claim 5, wherein the phosphine and/or phosphine oxide and/or phosphinate and/or phosphinite and/or phosphonite and/or phosphate and/or phosphonate, and/or the phosphate moiety is present in a T unit of the formula RPSiO3/2.

7. The silicone resin according to claim 4, wherein the group RP has the formula 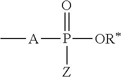
where A is a divalent hydrocarbon group having 1 to 20 carbon atoms, where R* is an hydrogen, alkyl or aryl group having 1 to 12 carbon atoms, and Z is a group of the formula —OR* or an alkyl, cycloalkyl, alkenyl, alkynyl or aryl group having 1 to 20 carbon atoms, and when 2 —OR* are present, R* can be the same or different.

8. The silicone resin according to claim 4, wherein the group RP has the formula 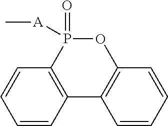
where A is a divalent hydrocarbon group having 1 to 20 carbon atoms.

9. The silicone resin according to claim 1 wherein the molar ratio of Metal atom to Si atom ranges from 0.01 to 2.

10. Method for the preparation of a silicone resin according to claim 1, wherein:
a. A Metal containing material optionally free of chlorine atoms;
b. A phosphorylated or nitrogenated alkoxysilane or hydroxysilane or alkoxysiloxane or hydroxysiloxane; and
c. Optionally an alkoxysilane or hydroxysilane or alkoxysiloxane or hydroxysiloxane;
are hydrolysed and condensed to form metallosiloxane Si—O-M bonds optionally in the presence of an inorganic filler.

11. Method according to claim 10 wherein the a. Metal containing material is at least one boron containing material selected from (i) boric acid of the formula B(OH)3, any of its salts or boric anhydride, (ii) boronic acid of the formula R1B(OH)2, (iii) alkoxyborate of formulae B(OR2)3 or R1B(OR2)2, a mixture containing at least two or more of a.(i), a.(ii) or a.(iii), where R1 and R2 are independently alkyl, alkenyl, aryl or arylalkyl substituents.

12. Method according to claim 10 wherein the a. Metal containing material has general formula M(R3)m where m=1 to 7 depending on the oxidation state of the Metal, and wherein the a. Metal containing material is selected from
i alkoxymetals where R3=OR′ and R′ is an alkyl group, and
ii metal hydroxyl where R3=OH.

13. (canceled)

14. (canceled)

15. A thermoplastic or thermoset organic polymer or rubbers or thermoplastic/rubbers blends composition comprising a thermoplastic or thermoset organic polymer or rubbers or thermoplastic/rubbers blends and a silicone resin as claimed in claim 1.

16. A thermoplastic or thermoset organic polymer composition according to claim 15 further comprising a flame retardant additive, wherein the flame retardant additive is selected from metal hydrates, zinc borates, phosphorus and/or nitrogen containing additives, carbon based additives, nanoclays, red phosphorous, silica, aluminosilicates, magnesium silicate (talc), silicone gum, sulfur based additives, or polyols.

17. A fire- or scratch and/or abrasion resistant coating on a substrate wherein the coating comprises a silicone resin according to claim 1.

18. (canceled)

19. A thermoplastic or thermoset organic polymer composition according to claim 16, wherein the flame retardant additive is selected from magnesium hydroxide, aluminum hydroxide, ammonium polyphosphate, boron phosphate, expandable graphite, carbon nanotubes, sulfonate, ammonium sulfamate, potassium diphenyl sulfone sulfonate (KSS), thiourea derivatives, pentaerythritol, dipentaerythritol, tripentaerythritol or polyvinylalcohol.
